(19) United States
(12) Patent Application Publication
(10) Pub. No.: US 2023/0116834 A1
(43) Pub. Date: Apr. 13, 2023

(54) COMMERCIALLY USEFUL RESINOUS COMPOUNDS AND COMPOSITIONS WITH OPTIMIZED SUSTAINABLE CONTENTS

(71) Applicant: ESTRON CHEMICAL, INC., Calvert City, KY (US)

(72) Inventors: Jiali Cai, Paducah, KY (US); Fred M. Allen, Paducah, KY (US); Terry R. Holler, Paducah, KY (US); Kenneth Whitson, Gilbertsville, KY (US); Nader Arang, Fort Lee, NJ (US)

(21) Appl. No.: 17/498,126

(22) Filed: Oct. 11, 2021

(51) Int. Cl. C09D 163/00; C09D 7/63; C09D 7/65; C08G 59/38

(52) U.S. Cl. CPC C09D 163/00; C09D 7/63; C09D 7/65; C08G 59/38; C08G 59/1488

(57) ABSTRACT

A resinous polymer compound used as a durable surface coating that maximizes content of epoxidized soybean oil (“ESO”) in lieu of bisphenol-A epoxy and hydrogenated bisphenol-A epoxy at various proportions to produce a less brittle, more elastic (flexible) film that, at various weight-percentages of substitution, presents a rapid enough reaction rate for efficient commercial production and yields a colorless and transparent film while lessening the amount of synthetic, petroleum-derived ingredients.

### BACKGROUND OF THE INVENTION

Certain polymer resins used to make coatings and adhesives applied to surfaces are created by reacting an arylsulfonamide such as toluenesulfonamide (tosylamide, or “TSA”) with at least one epoxy compound having at least one diepoxy and optionally at least one monoepoxy compound. Diepoxies generally used for such purposes, such as epoxy containing bisphenol-A diglycidyl ether (“BADGE”) and hydrogenated (cycloaliphatic) bisphenol-A diglycidyl ether, that is, BIS-A or BPA epoxy, are typically derived from petroleum sources. Amid growing consumer concerns over the acute and chronic health effects of petrochemical-based raw materials, there is a desire by resin and polymer manufacturers to replace the latter with naturally sourced or bio-based ingredients while preserving substantially all the esthetics, performance attributes and functionality of products. This is especially true in applications wherein humans interact with such products, such as fingernail lacquers, cosmetics, paints and coatings for floors, walls, furniture, cars, appliances, etc., as well as adhesives and sealants. BADGE, for example, includes two aromatic rings which, primarily due to resonance, are generally believed to be less reactive than aliphatic chains comprising double bonds. BADGE is thus persistent in the environment, non-renewable, and presents toxicity concerns. See, for example, Marqueno, A., Perez-Albaladejo, E., Flores, C., Moyano, E., & Porte, C., “Toxic effects of bisphenol A diglycidyl ether and derivatives in human placental cells,” Environmental Pollution 244 (2009): 513-521 (https://doi.org/10.1016/j.envpol. 2018.10.045 accessed Aug. 10, 2021).

Naturally sourced or bio-based organic chemicals are therefore attractive as substitutes for BADGE and other synthetic petroleum-based epoxies. See, for example, Zhang, C., Ding, R., Kessler, M., “Reduction of Epoxidized Vegetable Oils: A Novel Method to Prepare Bio-Based Polyols for Polyurethanes,” Macromolecular Rapid Communications 35 (2014): 1068-1074. Epoxidized Soybean Oil (“ESO”) presents aliphatic chains (generally triglycerides and fatty acids) susceptible to epoxidation, to render oxiranes capable of cross-linking with other compounds to induce plasticization. Absent aromatic rings and naturally sourced, ESO can substitute for BPA-epoxy and other, synthetic, petroleum-based ingredients. ESO is renewable and biodegradable and therefore an attractive alternative to BPA-based raw material for synthesis of said tosylamide/epoxy resins which contain no formaldehyde or BPA and can provide equivalent or improved coating properties such as durability, flexibility, adhesion, and gloss.

However, complete substitution of ESO into tosylamide/epoxy resin formulations in place of BPA-epoxy poses synthesis challenges which render the resulting polymer resin compounds and compositions unusable for commercial use because of cloudiness or haze, yellow to brown discoloration, and instability under prolonged heat during synthesis. Reaction time is also found to be significantly slower. Color, clarity, transparency, and a stable viscosity are essential requirements for use in certain coatings, especially, fingernail polishes or lacquers, and since long reaction times can impede manufacturing, complete substitution of ESO for BPA epoxy containing BADGE poses significant challenges.

What is needed is a resin that is based on sustainable raw material that reacts rapidly enough so as not to hinder economics of manufacturing and process time and maintains esthetics of clarity, transparency, gloss, adhesion, overall compatibility with a minimized reliance on BPA epoxy containing BADGE.

What is needed is an equivalent or better performing eco-friendly, less toxic resin producible from bio-based ESO in place of petroleum-derived BPA epoxy.

### FIELD OF THE INVENTION

The present invention relates to polymer resin compounds used for durable surface coatings, including, but not limited to, paints, polishes, lacquers, inks, and adhesives, collectively, “coatings.” The present invention relates particularly to an ESO-based coating that substitutes at least a portion of synthetic petroleum-sourced ingredients, specifically BPA epoxy containing BADGE, with renewable, biodegradable, and naturally sourced epoxy material to deliver a durable, flexible, adhesive polymer for coating surfaces.

### SUMMARY OF THE INVENTION

Coatings are typically manufactured by mixing pigments, solvents, resins and various plasticizers and additives together to form a homogeneous liquid that dries and/or cures when exposed to atmosphere to form a continuous film. Dried films should have strength, toughness, abrasion resistance, chemical resistance, gloss, depth of image and adhesion, Pigments provide color; solvents, fluidity; resins solidity, when dried; and various additives may be provided for additional purposes (s. a. UV resistance, antimicrobial properties, for example). Solvents are frequently derived from petroleum spirits, and comprise aromatic solvents such as benzol, alcohols, esters, ketones, and acetone. Synthetic resins commonly seen in the art include alkyds, acrylics, epoxies, cellulosics, polyesters, and polyurethanes. Naturally sourced resins seen in the art include resins based on linseed, coconut, and soybean oils.

Naturally sourced oils, such as soybean and other vegetable and nut oils, are suitable for epoxidation and are therefore applicable for use as resins in the creation of coatings. A problem, however, arises with use of epoxidized soybean oil (“ESO”), for example, as a material in place of bisphenol A (BIS-A or BPA) epoxy containing bisphenol A diglycidyl ether (“BADGE”) in formulating a coating where transparency is desired. Epoxy resins formed from ESO can be cloudy or hazy and may discolor yellow to brown thereby providing a finish contrary to use of a clear paint, polish, lacquer, or any transparent coating. Additionally, substituting ESO for BPA epoxy resin may decrease the reaction rate to render production untenable at an industrial scale. However, use of ESO and other naturally-sourced polymers in place of BPA epoxy and/or tosylamide/formaldehyde resin is preferable, especially in the cosmetics industry where synthetic compounds present allergenic and toxicity concerns.

The instant ESO-based resinous composition, therefore, has been devised to present a clear and colorless product with significant portions of BADGE and formaldehyde eliminated.

Substituting resins to reduce petrochemical ingredients is known in the art. For example, a high-performance resin is set forth in U.S. Pat. No. 4,996,284. Sulfonamide is reacted with an epoxy resin in the presence of a Lewis acid to create a formaldehyde-free coating. In U.S. Pat. No. 5,001,175 an aryl sulfonamide is reacted with at least one diepoxy compound and optionally one monoepoxy compound to produce a resin with a molecular weight between 450 to 800. In the present invention, ESO is used to replace epoxy containing BADGE (BPA epoxy) and hydrogenated BADGE (HBPA epoxy resin) in reaction with TSA to produce a more naturally sourced bio-based product. Data show that the ESO incorporates into the polymer in like capacity as BPA epoxy containing BADGE and HBPA. Additionally, data show that the ESO may act like a plasticizer to present a more flexible resin. A more resilient (less brittle) coating is therefore producible from more naturally-sourced ingredients while, in some embodiments, transparency of the coating is also maintained. At certain weight-percentages of substitution, the rate of reaction can be optimized.

The main constituents of a fingernail polish or lacquer formulation are a film former, a resin, colorants, plasticizer, and solvents. Nitrocellulose is the primary film former, providing a combination of properties for toughness, durability, solubility, and solvent release. The commonly used viscosity grades of nitrocellulose are so-called RS ¼ second, which has a high solids content, but poor wear resistance; RS ½ second, which has better wear resistance and a reasonably high non-volatile content; and lastly, RS 5-6 second and RS 60-80 second, which have higher viscosities than the RS ½ second grade. The term RS refers to the RS brand of nitrocellulose with a nitrogen content of 11.2-12.8% with solubility in esters, ketones, and glycol ethers manufactured by Hercules, Inc. The terms ¼ second, ½ second, 5-6 second, etc. represent viscosity and refer to the time it takes for a ball to fall to a given depth in the material. Nitrocellulose is supplied in 70% concentrations, wet with 30% ethyl or isopropyl alcohol. Fingernail polish grade nitrocellulose has a low moisture content.

Various resins and plasticizers are used in nitrocellulose formulations to improve gloss, adhesion, durability, and balance of properties. Tosylamide/formaldehyde and tosylamide/epoxy resins discussed herein have traditionally been used to provide the optimum balance of properties for gloss, compatibility, adhesion, stability, and durability between a multitude of pigments and fillers used by the industry. Addition of this resin and others permits an increase in solids content without appreciably increasing lacquer viscosity. Nail enamels, using a minimum of coats, are more easily attained. The solvent combinations used in fingernail lacquer technology usually consist of isopropanol, which is used to wet the nitrocellulose, n-butyl acetate, ethyl acetate, and other esters and ketones.

Polytex™ E-75, Polytex™ E-100, and Polytex™ NX-55, manufactured by Estron Chemical (Calvert City, Ky.), are examples of formaldehyde-free TSA-based BPA and HBPA epoxy resin that have been used by the industry as modifiers for nitrocellulose to impart gloss, adhesion, durability, and stability. Said products are specifically designed to enhance gloss, compatibility, color stability, and overall coating durability of fingernail polishes and lacquers. The ability to produce a Polytex variant containing the maximum content of ESO and minimum content of BPA epoxy or HBPA epoxy, in whole or in part, without significantly affecting the esthetics of clear or pigmented nitrocellulose fingernail lacquer formulations, provides the cosmetic industry with new, safer, and healthier resins having a higher concentration of sustainable raw materials.

Further, the ESO substituting for BPA epoxy and HBPA epoxy, functions as a plasticizer, offering a potential advantage for use, for example, for softer, more flexible, and less brittle polymer coatings, specifically when used for a fingernail polish or lacquer.

Thus, has been broadly outlined the more important features of the present ESO-based surface coating so that the detailed description thereof that follows may be better understood and in order that the present contribution to the art may be better appreciated.

Objects of the present ESO-based resinous compounds, along with various novel features that characterize the invention are particularly pointed out in the claims forming a part of this disclosure. For better understanding of the ESO-based compositions, their operating advantages and specific objects attained by their uses, refer to the accompanying drawings and description.

### BRIEF DESCRIPTION OF THE DRAWINGS

### FIGURES

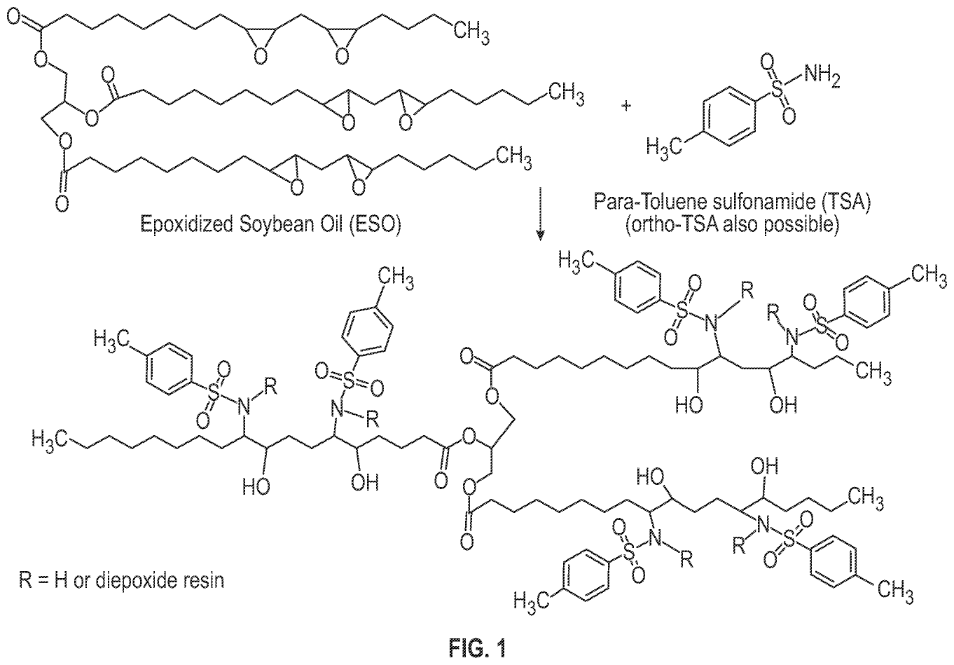

FIG. 1 is a diagrammatic representation of an example embodiment of a diepoxide resin produced when ESO is reacted with para-TSA.

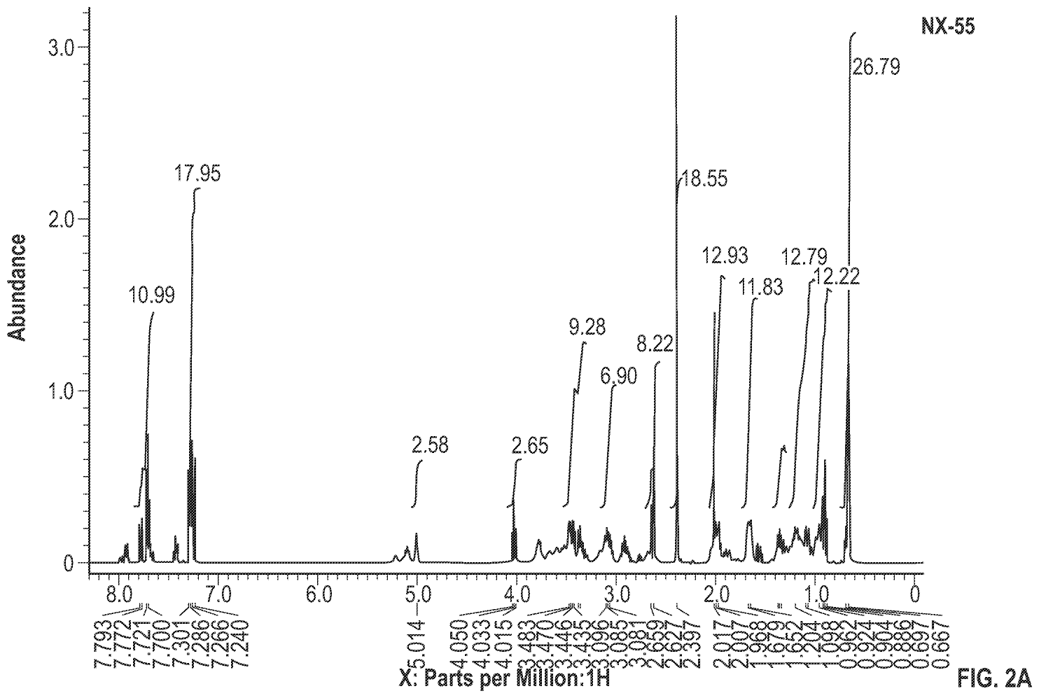

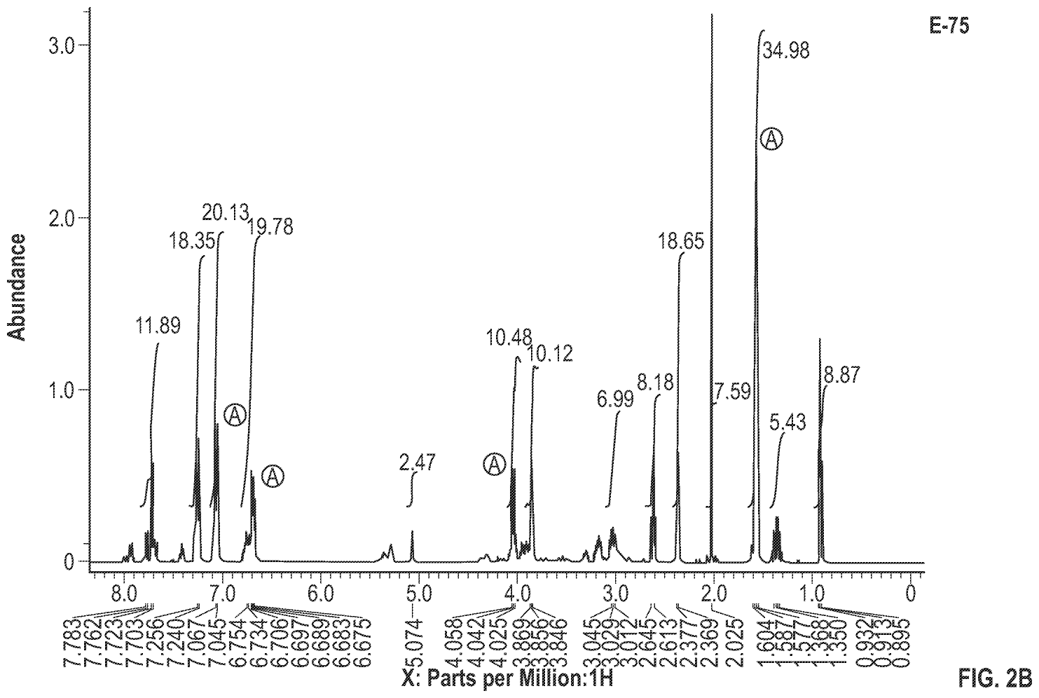

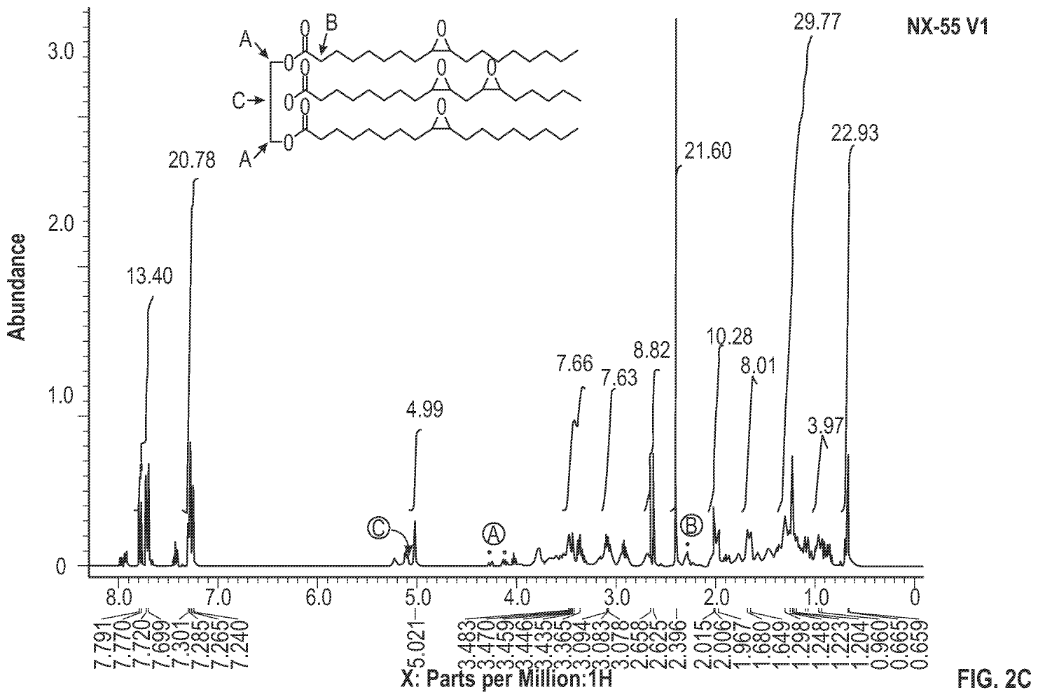

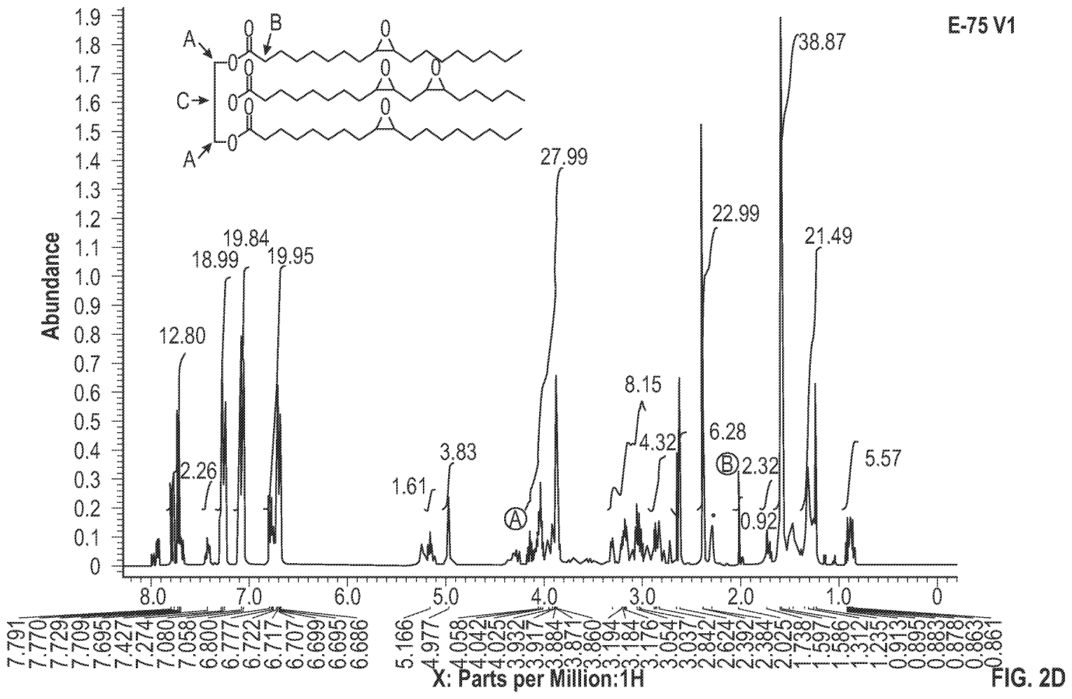

FIGS. 2A and 2B show Proton Nuclear Magnetic Resonance (“¹HNMR”) spectroscopy data for samples of TSA-HBPA epoxy polymers and TSA-BPA epoxy polymers designated Polytex NX-55 and E-75, respectively.

FIGS. 2C and 2D show ¹HNMR spectroscopy data for derivative products where ESO was successfully incorporated into the material designated NX-55V1 and E-75V1.

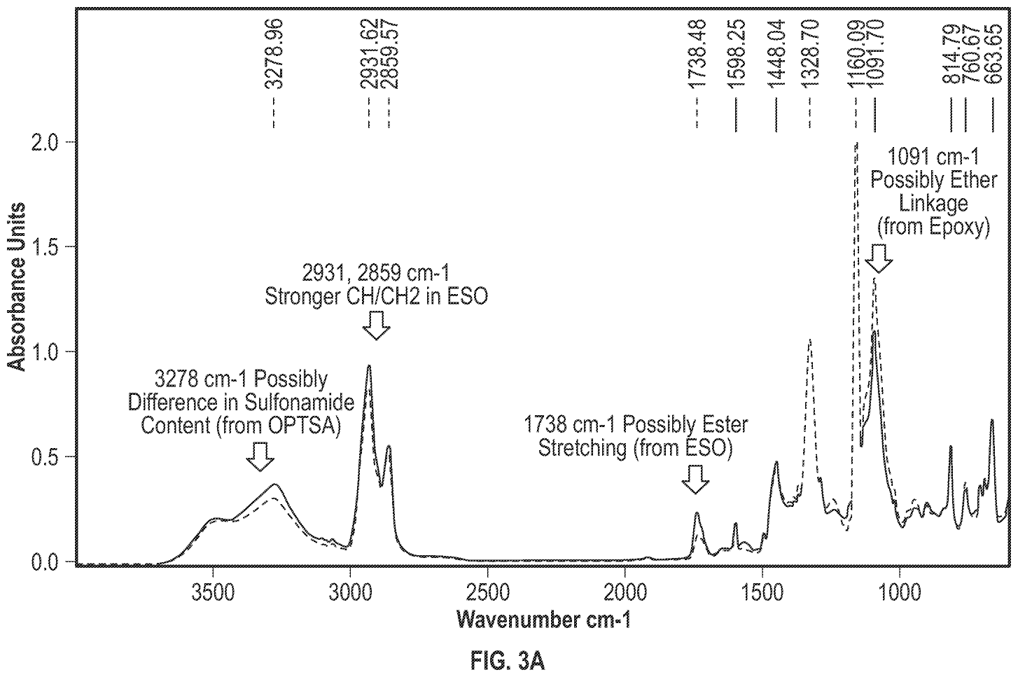

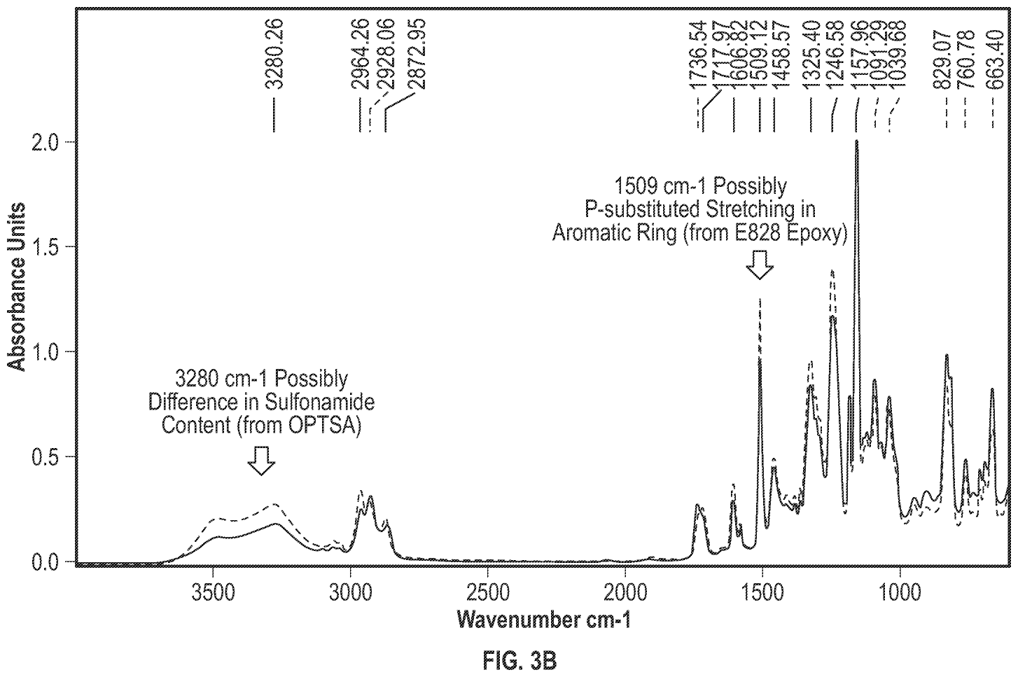

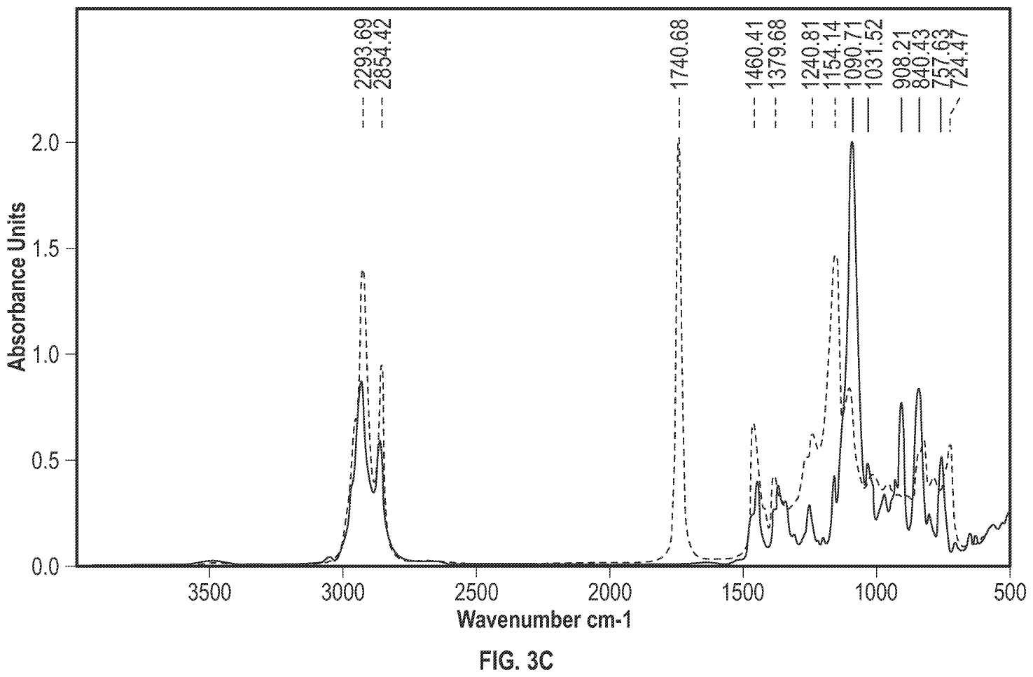

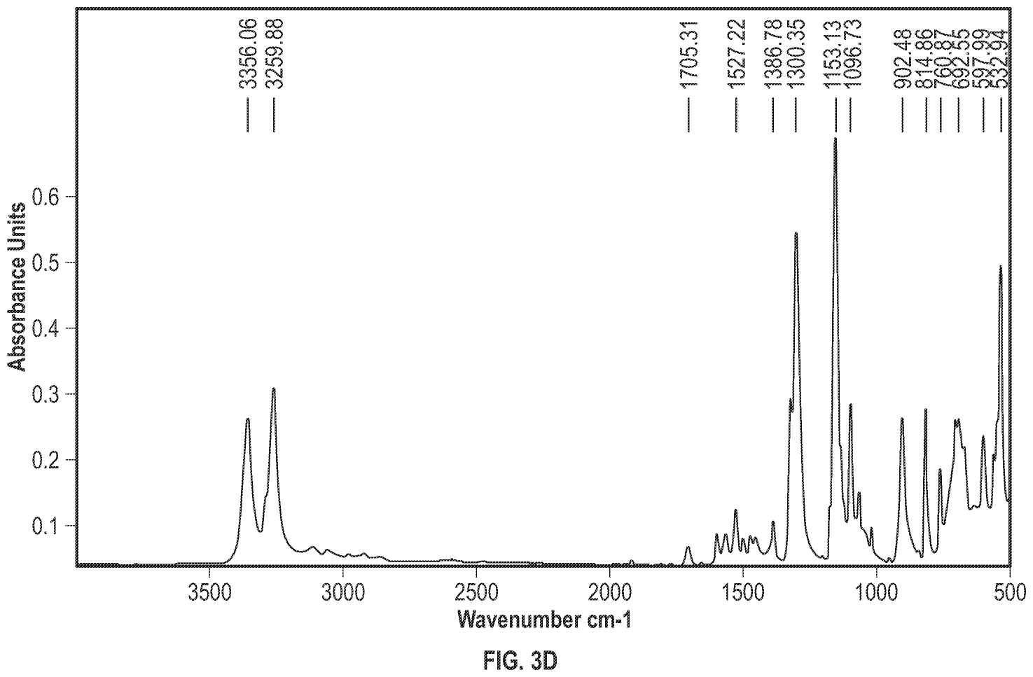

FIGS. 3A and 3B are Fourier Transform Infrared (“FTIR”) spectroscopy data showing like characteristics for ESO-substituted resins, NX-55V1 and E-75V1.

FIG. 3C is FTIR spectroscopy data for ESO versus an epoxy resin.

FIG. 3D is FTIR spectroscopy data for TSA.

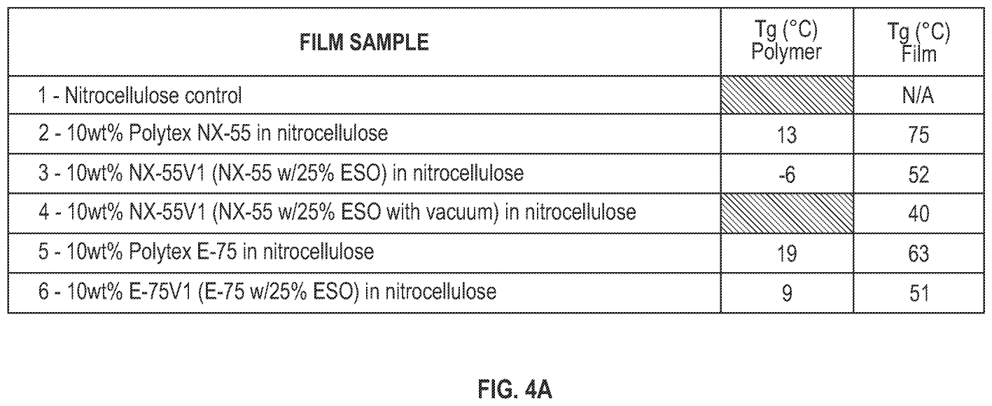

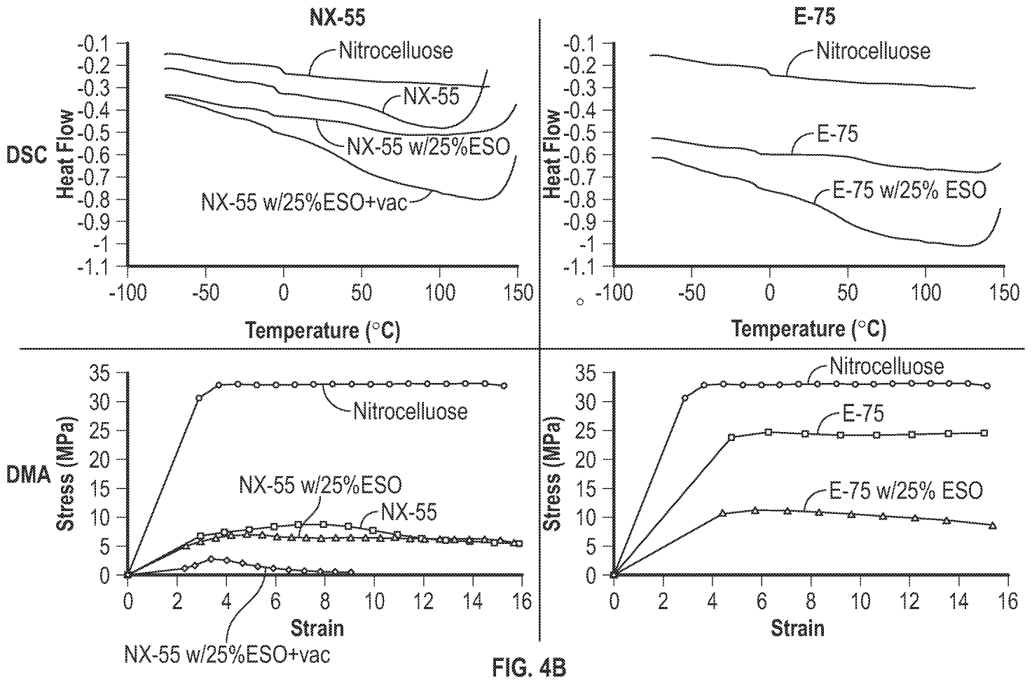

FIG. 4A shows Glass Transition Temperature (“Tg”) data for nitrocellulose films made with ESO-free polymers and also ESO-substituted material.

FIG. 4B shows Differential Scanning calorimetry (“DSC”) and Dynamic Mechanical Analysis (“DMA”) data for nitrocellulose films made with ESO-free polymers and also ESO-substituted material.

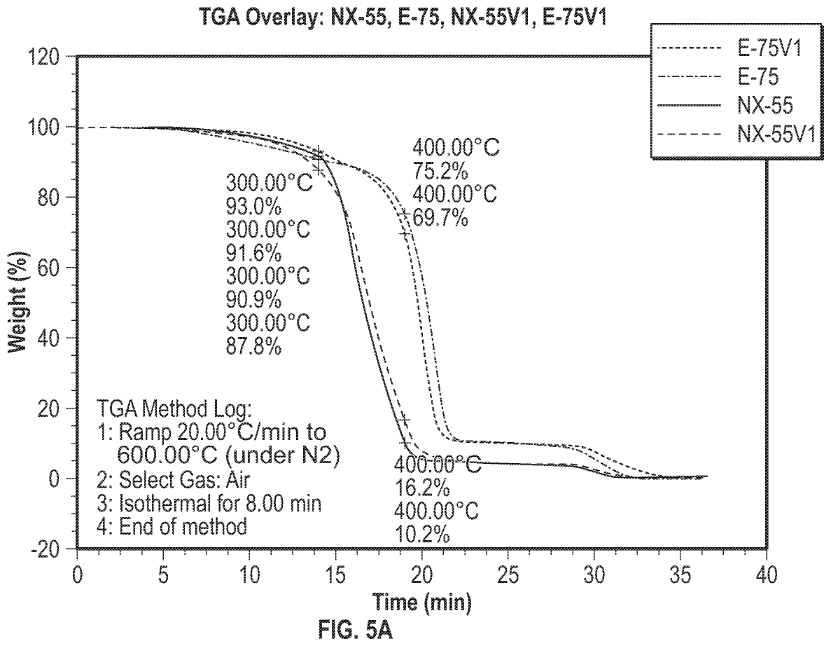

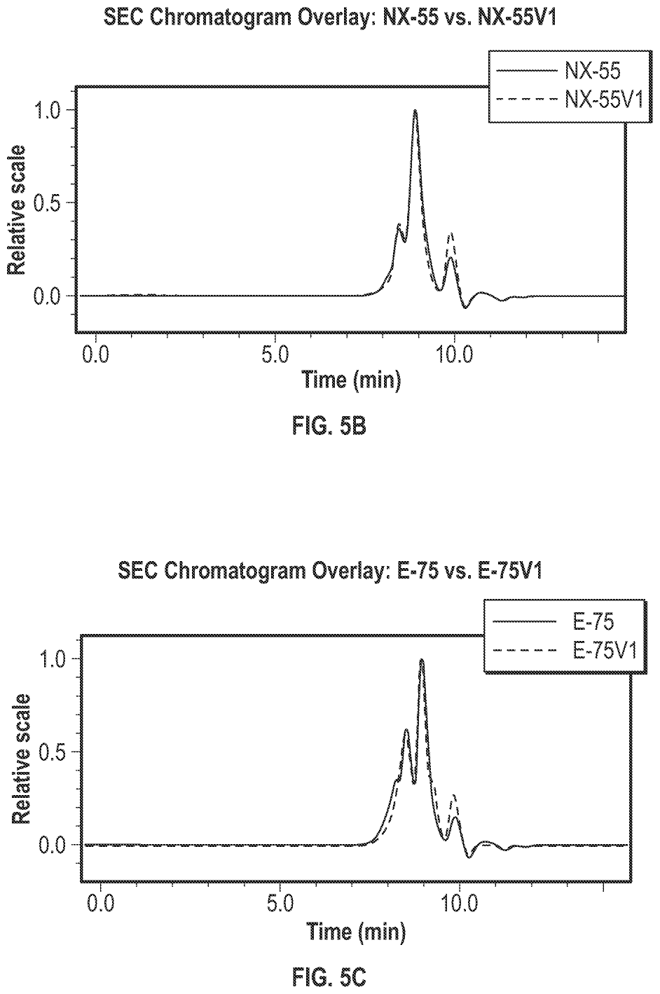

FIG. 5A shows Thermogravimetric Analysis (“TGA”) for NX-55V1 and E-75V1 relative to epoxy resins NX-55 and E-75.

FIG. 5B shows Size-Exclusion Chromatography (“SEC”) overlay between epoxy resin NX-55 and NX-55V1.

FIG. 5C shows SEC overlay between epoxy resin E-75 and E-75V1.

### DETAILED DESCRIPTION OF THE DRAWINGS

FIG. 1 illustrates an example embodiment of a diepoxide resin formed from ESO reacted with para-TSA (similar results from reaction with ortho-TSA, or a mixture of para and ortho isomers, are suggested). The amide group of the TSA attaches to the oxirane groups of the ESO enabling the nitrogen to join to the aliphatic chain with the formation of hydroxyl group on the adjacent carbon. The result is an epoxidized resin with bio-based backbone. The diagrammatic form illustrated is for example purposes only. Groups identified by R could include hydrogen or other diepoxide resin.

Two control epoxy resins were analyzed relative to two derivative resins wherein BPA epoxy was substituted with varying proportions of ESO. These formulations are listed in Tables 1 through 3 below. Polytex NX-55 and Polytex E-75, products manufactured by Estron Chemical (Calvert City, Ky.) represent the control polymers. The two derivative products are styled NX-55V1 and E-75V1.

TABLE 1

| Polytex NX-55 variant | Polytex E-75 variant |
|---|---|
| NX-55V1 (25 wt % | E-75V1 (25 wt % |
| ESO-substituted NX-55 variant) | ESO-substituted E-75 variant) |

TABLE 2

| | Polytex NX-55 | NX-55V1 | |
|---|---|---|---|
| Polytex NX-55 | Control | (ESO-sub) | |
| % NV as-is | 74.8% | 75.0% | |
| % NV, lab-stripped solid | 99.1% | 98.2% | |
| Softening point, | 69° C. | 52° | C. |
| lab-stripped solid | | | |
| Mn, Mw, Mz, PDI, | 740, 970, 1200, | 820, 1000, 1200, | |
| online dn/dc¹ | 1.3, 0.123 | 1.2, 0.114 | |
| TGA (nitrogen to 600° C. | % wt remaining at | % wt remaining at | |
| at 20° C./min)² | 300° C.: 91.6% | 300° C.: 87.8% | |
| (evaporated for 2 days | % wt remaining at | % wt remaining at | |
| in 80° C. vacuum oven) | 400° C.: 10.2% | 400° C.: 16.2% | |
| Tg by DSC (evaporated | 13° C. | −6° | C. |
| for 2 days in 80° C. | | | |
| vacuum oven) | | | |

Note¹
Molecular weight data should be considered relative only. MWs reported to 2 significant figures. Peak at approx. 10 min (believed to be TSA) not included in calculations.
Note²
Shape/morphology of low-Tg resins is difficult to control when preparing TGA samples and may affect results.

TABLE 3

| | Polytex E-75 | | E-75V1 | |
|---|---|---|---|---|
| Polytex E-75 | Control | | ESO-sub) | |
| % NV as-is | 73.8% | | 73.8% | |
| % NV, lab-stripped solid | 97.7% | | 98.5% | |
| Softening point, | 75 | C. | 62 | C. |
| lab-stripped solid | | | | |
| Mn, Mw, Mz, PDI, | 920, 1200, 1600, | | 800, 1100, 1400, | |
| online dn/dc¹ | 1.3, 0.158 | | 1.3, 0.146 | |
| TGA (nitrogen to 600° C. | % wt remaining at | | % wt remaining at | |
| at 20° C./min)² | 300° C.: 90.9% | | 300° C.: 93.0% | |
| (evaporated for 2 days | % wt remaining at | | % wt remaining at | |
| in 80° C. vacuum oven) | 400° C.: 75.2% | | 400° C.: 69.7% | |
| Tg by DSC (evaporated | 19° | C. | 9° | C. |
| for 2 days in 80° C. | | | | |
| vacuum oven) | | | | |

Note¹
Molecular weight data should be considered relative only. MWs reported to 2 significant figures. Peak at approx. 10 min (believed to be TSA) not included in calculations.
Note²
Shape/morphology of low-Tg resins is difficult to control when preparing TGA samples and may affect results.

FIGS. 2A and 2B show Proton Nuclear Magnetic Resonance (“¹HNMR”) spectroscopy data for two samples of a TSA reacted with BPA epoxy polymer, styled NX-55 and E-75 respectively. FIGS. 2C and 2D show ¹HNMR spectroscopy data for derivative ESO-substituted materials, NX-55V1 and E-75V1. The ¹HNMR data was collected on 21 May 2021 by K. Miller at Murray State University.

As shown in the corresponding Figures, the spectra indicate that ESO was successfully incorporated into the material. Three signals related to the ESO are discernible. A triplet (labeled “B”) was identified at 2.3 ppm, which is assigned to the —CH₂— adjacent to the carbonyl. Two smaller multiplets (labeled as “A”) were observed for the —CH₂— groups in the glycerol backbone of the ESO around 4.1 to 4.3 ppm. Finally, a signal at approximately 5.0 ppm is sometimes observable for the —CH— group of the glycerol backbone (labeled “C”). It is further suspected that some epoxides are present between 2.9 to 3.2 ppm. See Macromol. Rapid Comm. 2014, 35, 1068-1074 for sample ¹HNMR spectrum of ESO.

FIGS. 3A, 3B, 3C, show Fourier Transform Infrared (“FTIR”) data in relation to FTIR data of TSA, shown in FIG. 3D. Data was collected 7 Jun. 2021 at Estron Chemical by K. Whitson and A. Tumuluri. TSA shows model spectrum illustrated in FIG. 3D. Peaks corresponding to wavenumbers 3356, 3260 cm⁻¹ to significant peaks at 1369, 1153 and 533 cm⁻¹ demark the curve.

FIG. 3A shows the NX-55V1 ESO-substituted polymer spectrum relative to the NX-55 polymer (control). Differences relative the NX-55 spectrum include increased absorbance peaks for NX-55V1 at wavenumbers 3279 cm⁻¹ and 2932 and 2860 cm⁻¹ and decreased absorbance at 1092 cm⁻¹. The increased absorbance at 3279 cm⁻¹ may suggest a difference in the overall TSA content and the increased absorbance at 2932 cm⁻¹ suggests stronger —CH— and —CH₂— representations in the NX-55V1. The decreased absorbance at 1092 cm⁻¹ may result from differences via ether linkage in the TSA versus ESO-substituted polymer.

FIG. 3B shows the E-75V1 ESO-substituted polymer spectrum relative to the E-75 polymer (control). Significant differences observed include decreased absorbance around wavenumber 3280 cm⁻¹, suggesting a difference in the TSA content. Decreased absorbance at 1509 cm⁻¹ may also suggest C—C stretching due to para-substitution in the aromatic ring.

FIG. 3C shows FTIR data for ESO versus an epoxy resin and illustrates ESO increased absorbance at the wavenumbers 2924 and 2854 cm⁻¹. ESO shows dramatic absorbance at 1741 cm⁻¹ relative to epoxy resin, and a shifted spectrum at lower wavenumbers, approximately 1240 to 1730 cm⁻¹. FIG. 3D shows FTIR data for TSA.

FIG. 4A shows Glass Transition Temperature (“Tg”) for nitrocellulose polymer and film containing 10 wt % Polytex NX-55 as-made compared with 10 wt % NX-55V1, a composition of NX-55 with 25% ESO substitution, and 10 wt % Polytex E-75 as-made compared with E-75V1, a composition of E-75 having 25% ESO substitution. Reduced Glass Transition Temperatures are measurable in the case of ESO substituted materials.

FIG. 4B shows Differential Scanning calorimetry (“DSC”) data for nitrocellulose film to represent a nail lacquer application, nitrocellulose containing 10 wt % Polytex E-75 as-made, and 10 wt % of an E-75 polymer with 25 wt % substituted ESO for BPA epoxy. Nitrocellulose (RS ½ sec; 70% solids in IPA and n-butyl acetate) supplied by Cosmetics Coatings Corporation (Carlstadt, N.J.). The DSC data for the polymers was collected on 3 Jun. 2021 by K. Whitson at Estron Chemical. The DSC data for the polymer films was collected on 19 Jul. 2021 by K. Miller at Murray State University. A result appears to be that the softening points and glass transition temperature (“Tg”) values for the ESO-substituted materials are less than that of the nitrocellulose containing Polytex resins NX-55 and E-75 as-made.

FIG. 4B also shows Dynamic Mechanical Analysis (“DMA”) data for nitrocellulose films made with 10 wt % Polytex NX-55 and E-75 as-made relative to derivatives where HBPA epoxy and BPA epoxy were substituted with ESO respectively. In the NX-55 graph, ESO substitutes included an NX-55 polymer with 25 wt % ESO substituted and an NX-55 polymer with a 25 wt % ESO plus vacuum substituted. In the E-75 graph, the E-75 epoxy resin included a 25 wt % ESO substitute. In all data, the nitrocellulose films made with ESO-substituted material showed decreased stress relative the epoxy resin absent ESO, although strain (elasticity) was comparable.

FIG. 5A shows Thermogravimetric Analysis (“TGA”) data for epoxy resins NX-55 and E-75 relative to ESO-substituted epoxies, NX-55V1 and E-75V1. Data was collected on 7 Jun. 2021 at Estron Chemical by K. Whitson and A. Tumuluri. FIG. 5B shows Size Exclusion Chromatography (“SEC”) overlay of epoxy resin NX-55 relative to ESO-substituted NX-55V1. FIG. 5C shows SEC overlay of epoxy resin E-75 relative to ESO-substituted E-75V1.

From the above data, it appears the ESO-substituted resin material, specifically TSA-BPA epoxy and HBPA epoxy, enhances plastic behavior, offering a potential advantage for softer, more flexible, and less brittle polymer coatings, useful for example, when used in a fingernail polish or lacquer formulation.

What is claimed is:

1. An ESO-based resinous composition that may be used as a durable surface coating, including paint, polish, lacquer, enamel, said resinous composition comprising:
a product of an arylsulfonamide and at least one epoxy compound comprising at least one diepoxy compound and optionally at least one monoepoxy compound;
wherein between 1 to 100 weight-percent of bisphenol-A epoxy is substituted with epoxidized soybean oil.

2. The ESO-based resinous composition of claim 1 wherein a substitution of no more than 50 weight-percent is used in place of bisphenol-A epoxy resin to reduce the glass transition temperature by at least 10° C. thereby making the final coating less brittle and more elastic and therefore more flexible.

3. The ESO-based resinous composition of claim 1 wherein a substitution of epoxidized soybean oil in place of bisphenol-A epoxy optimizes the rate of reaction.

4. The ESO-based resinous composition of claim 1 wherein the weight-percent of epoxidized soybean oil substituted for bisphenol-A epoxy resin minimizes haze and/or discoloration of the final product.

5. An ESO-based resinous composition comprising 25 weight-percent epoxidized soybean oil, said coating further comprising:
approximately 1 part bisphenol A/epichlorohydrin derived liquid epoxy resin;
approximately 0.6 to 0.9 parts n-butyl acetate;
approximately 1 to 1.1 parts tosylamide;
approximately 0.0007 parts triethylamine;
approximately 0.3 to 0.4 epoxidized soybean oil
